(19) United States
(12) Patent Application Publication
(10) Pub. No.: US 2013/0167017 A1
(43) Pub. Date: Jun. 27, 2013

(54) DISPLAY PROCESSING DEVICE, DISPLAY PROCESSING METHOD, AND INFORMATION STORAGE MEDIUM STORING PROGRAM

(71) Applicants: Teruya Ikegami, Tokyo (JP); Haruka Yoshida, Tokyo (JP)

(72) Inventors: Teruya Ikegami, Tokyo (JP); Haruka Yoshida, Tokyo (JP)

(73) Assignee: NEC CORPORATION, Tokyo (JP)

(21) Appl. No.: 13/821,306

(22) PCT Filed: Jul. 15, 2011
(86) PCT No.: PCT/JP2011/004062

§ 371 Date: Mar. 7, 2013

(30) Foreign Application Priority Data
Sep. 9, 2010 (JP) 2010-201781

(51) Int. Cl. G06F 17/21

(52) U.S. Cl. CPC G06F 17/212
USPC 715/243

(57) ABSTRACT

A display processing device includes a storage unit (10) which stores identifiers in association with a plurality of pieces of viewing information to be output to a screen, at least one identifier is associated with a plurality of pieces of the viewing information, a viewing information output unit (20) which is configured to output a plurality of the pieces of viewing information to the screen simultaneously and outputs the viewing information to the screen, an output viewing information identification unit (30) which identifies the viewing information being output to the screen, an identifier determination unit (40) which references the storage unit (10) and determines an identifier to be output to the screen on the basis of the viewing information identified by the output viewing information identification unit (30), and an identifier output unit (50) which outputs the identifier determined by the identifier determination unit (40) to the screen.

### TECHNICAL FIELD

The present invention relates to a display processing device, a display processing method, and a program.

### BACKGROUND ART

A technique which outputs a plurality of pieces of information to a screen simultaneously is known. For example, a technique which collectively outputs a plurality of pieces of information to a portal screen of a predetermined application is known.

A technique is known in which, on a screen (hereinafter, referred to as “OS screen”) realized by an operating system (OS) controlling a plurality of applications, information which is processed by each of a plurality of applications is displayed in each of a plurality of windows, and a plurality of windows are output in various ways, for example, in parallel or in an overlapping manner.

According to such techniques, it is convenient because the user can output a plurality of pieces of information to the screen and can perform one task while alternately viewing a plurality of pieces of information or can perform two or more tasks in parallel while alternately viewing a plurality of pieces of information.

A technique involved in the relevant technique is described in, for example, Patent Document 1.

Patent Document 1 describes a portal screen configuration device including a unit which generates a Web page on the basis of a screen configuration definition which defines the screen configuration of the Web page for each identifier and a screen configuration change definition which defines a rule for changing the screen configuration definition for each user identifier. The portal screen configuration device further includes a unit which acquires a screen configuration definition and a screen configuration change definition corresponding to a user identifier acquired on the basis of request data received from a client, a unit which acquires a user-specific screen configuration change factor from the portal screen configuration device or the client, a unit which changes the screen configuration definition on the basis of the screen configuration change definition and the user-specific screen configuration change factor, and a unit which generates and processes data of the Web page on the basis of the changed screen configuration definition.

### RELATED DOCUMENT

### Patent Document

[Patent Document 1] Japanese Laid-Open Patent Publication No. 2006-107012

### DISCLOSURE OF THE INVENTION

The inventors have found that the technique (hereinafter, referred to as “relevant technique”) which outputs a plurality of pieces of information simultaneously has the following problems.

It would appear that the user who performs predetermined tasks while viewing the screen to which a plurality of pieces of information are output simultaneously wants to easily recognize which task is associated with each piece of information output to the screen.

When tasks and information are associated with each other on a one-to-one basis, the user recognizes each piece of information output to the screen, thereby easily recognizing which task is associated with each piece of information output to the screen.

However, as described above, the user may perform predetermined tasks in various ways, for example, the user performs one task while alternately viewing a plurality of pieces of information output to the screen or performs two or more tasks in parallel while alternately viewing a plurality of pieces of information. A piece of information may be used in a plurality of tasks. That is, a plurality of pieces of information may be associated with one task, or a piece of information may be associated with a plurality of tasks. For this reason, there is a problem in that the user who faces the screen to which a plurality of pieces of information are output simultaneously can easily recognize which task is associated with each piece of information output to the screen.

Accordingly, an object of the invention is to provide a technique which, in a state where a plurality of pieces of information are output to the screen, allows the user to easily recognize which task is associated with each piece of information output to the screen.

The invention provides a display processing device including a storage unit which stores identifiers in association with a plurality of pieces of viewing information to be output to a screen, at least one identifier is associated with a plurality of pieces of the viewing information, a viewing information output unit which is configured to output a plurality of the pieces of viewing information to the screen simultaneously and outputs the viewing information to the screen, an output viewing information identification unit which identifies the viewing information being output to the screen, an identifier determination unit which references the storage unit and determines an identifier to be output to the screen on the basis of the viewing information identified by the output viewing information identification unit, and an identifier output unit which outputs the identifier determined by the identifier determination unit to the screen.

The invention provides a program which causes a computer to function as a storage unit which stores identifiers in association with a plurality of pieces of viewing information to be output to a screen, at least one identifier is associated with a plurality of pieces of the viewing information, a viewing information output unit which is configured to output a plurality of the pieces of viewing information to the screen simultaneously and outputs the viewing information to the screen, output viewing information identification unit which identifies the viewing information being output to the screen, an identifier determination unit which references the storage unit and determines an identifier to be output to the screen on the basis of the viewing information identified by the output viewing information identification unit, and an identifier output unit which outputs the identifier determined by the identifier determination unit to the screen.

The invention provides a display processing method including a viewing information output step of outputting at least one of a plurality of pieces of viewing information to a screen, an output viewing information identification step of identifying the viewing information being output to the screen, an identifier determination step of referencing a storage unit which stores identifiers in association with a plurality of the pieces of viewing information to be output to a screen, at least one identifier is associated with a plurality of pieces of the viewing information, and determining an identifier to be output to the screen on the basis of the viewing information identified in the output viewing information identification step, and an identifier output step of outputting the identifier determined in the identifier determination step to the screen.

According to the invention, in a state where a plurality of pieces of information are output to the screen, it becomes possible for the user to easily recognize which task is associated with information output to the screen.

### BRIEF DESCRIPTION OF THE DRAWINGS

The foregoing and other objects, features, and advantages will become more fully understood by the following preferred embodiments and the accompanying drawings.

FIG. 1 is a diagram schematically showing an example of screen display which is realized by a display processing device of this embodiment.

FIG. 2 is a diagram schematically showing an example of information which is held by the display processing device of this embodiment.

FIG. 3 is an example of a functional block diagram of the display processing device of this embodiment.

FIG. 4 is a flowchart showing an example of the flow of processing of the display processing device of this embodiment.

FIG. 5 is an example of a functional block diagram of the display processing device of this embodiment.

FIG. 6 is a diagram schematically showing an example of screen display which is realized by the display processing device of this embodiment.

FIG. 7 is an example of a functional block diagram of the display processing device of this embodiment.

FIG. 8 is a diagram schematically showing an example of screen display which is realized by the display processing device of this embodiment.

FIG. 9 is a diagram schematically showing an example of screen display which is realized by the display processing device of this embodiment.

FIG. 10 is a diagram schematically showing an example of screen display which is realized by the display processing device of this embodiment.

FIG. 11 is an example of a functional block diagram of the display processing device of this embodiment.

FIG. 12 is a diagram schematically showing an example of screen display which is realized by the display processing device of this embodiment.

FIG. 13 is a diagram schematically showing an example of information which is held by the display processing device of this embodiment.

FIG. 14 is an example of a functional block diagram of the display processing device of this embodiment.

FIG. 15 is a diagram schematically showing an example of screen display which is realized by the display processing device of this embodiment.

FIG. 16 is an example of a functional block diagram of the display processing device of this embodiment.

FIG. 17 is a diagram schematically showing an example of screen display which is realized by the display processing device of this embodiment.

FIG. 18 is a diagram schematically showing an example of screen display which is realized by the display processing device of this embodiment.

FIG. 19 is a diagram schematically showing an example of screen display which is realized by the display processing device of this embodiment.

FIG. 20 is a diagram schematically showing an example of information which is held by the display processing device of this embodiment.

### DESCRIPTION OF EMBODIMENTS

Hereinafter, embodiments of the invention will be described with reference to the drawings.

Each unit which constitutes a display processing device of this embodiment is realized by an arbitrary combination of hardware and software focusing on a CPU of an arbitrary computer, a memory, a program loaded on the memory (including not only a program stored in advance in the memory when shipment of the device but also a program downloaded from a storage medium, such as a CD, a server on Internet, or the like), a storage unit, such as a hard disk, which stores the program, and an interface for network connection. It is understood by those skilled in the art that various modifications may be made to the realization method and the device.

A functional block diagram which is used in the description of this embodiment shows a block in functional units, instead of a configuration in hardware units. In these drawings, although the display processing device of this embodiment is realized by a single device, the realization means is not limited thereto. That is, a physically divided configuration or a logically divided configuration may be provided.

### Embodiment 1

First, the outline of a display processing device of this embodiment will be described. In this embodiment, an example where the display processing device outputs a plurality of pieces of information to a portal screen of a data center operation and maintenance support application simultaneously. The data center operation and maintenance support application is an application which collects all pieces of information associated with data center operation and maintenance, outputs information to an output device, such as a display, or the like. According to this application, an administrator who operates and manages the data center can operate the data center safely and efficiently. The display processing device of this embodiment may be configured to output a plurality of pieces of information to the portal screens of other applications simultaneously.

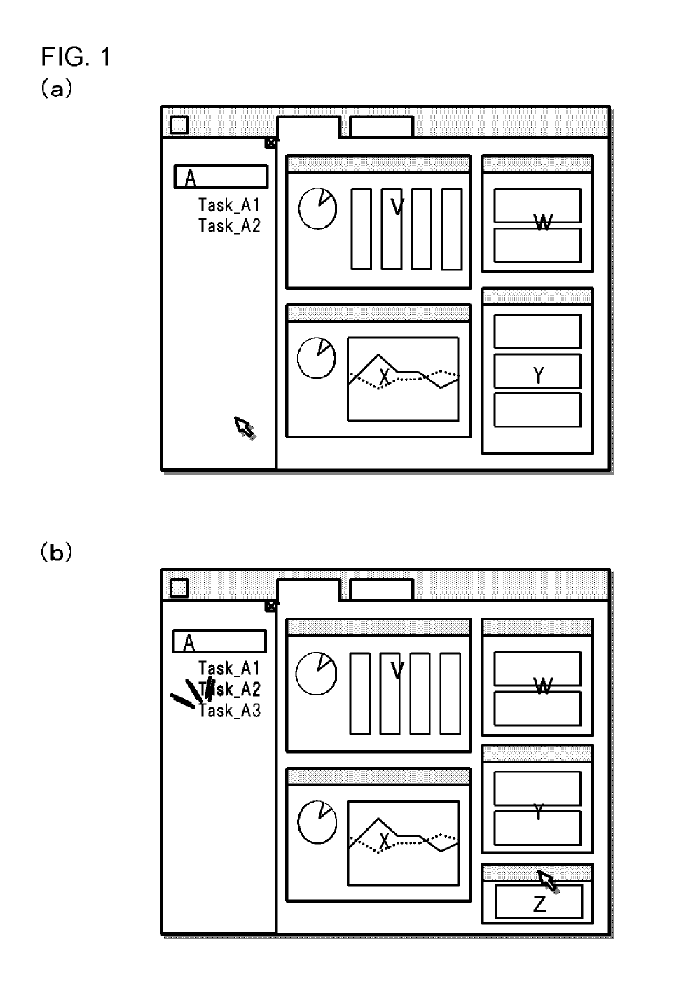

FIG. 1 is a diagram schematically showing an example of a display screen which is realized by the display processing device of this embodiment, and an example of a portal screen of a data center operation and maintenance support application (hereinafter, simply referred to as “portal screen”). As shown in FIG. 1(a), the display processing device of this embodiment can output a plurality of pieces of information (V, W, X, and Y) to the portal screen simultaneously.

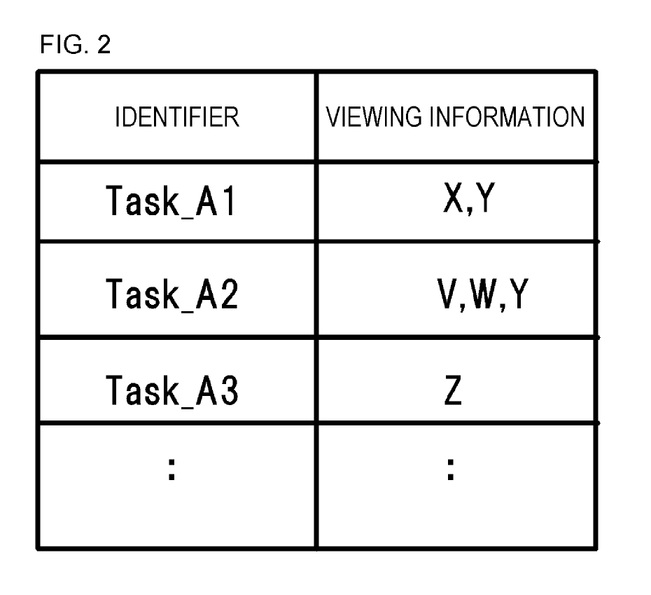

As shown in FIG. 2, the display processing device of this embodiment stores identifiers in association with at least one piece of information to be output to the portal screen in advance. That is, the display processing device of this embodiment stores arbitrary combinations of a plurality of pieces of information to be output to the portal screen in association with identifiers for identifying the combination. The combination may be a combination of a plurality of pieces of information to be viewed simultaneously when performing one task. In FIG. 2, for example, a combination of information X and Y is associated with an identifier “Task_A1”.

If information (in the case of the screen of FIG. 1(a), V, W, X, and Y) output to the portal screen is identified, the display processing device of this embodiment specifies combinations output to the portal screen among the combinations of information stored in advance in association with the identifiers with reference to information shown in FIG. 2. The identifiers associated with the specified combinations are output to the portal screen. In the case of the portal screen shown in FIG. 1(a), the display processing device specifies combinations of “X, Y” and “V, W, Y” with reference to information shown in FIG. 2, and outputs identifiers “Task_A1” and “Task_A2” associated with the combinations to the portal screen.

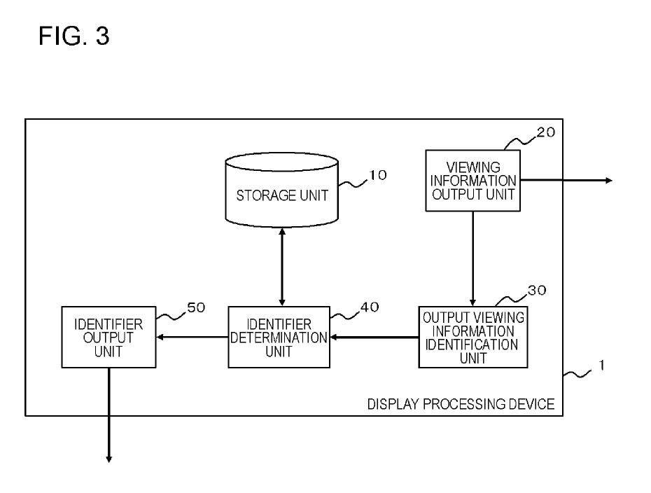

Hereinafter, the display processing device of this embodiment will be described in detail with reference to FIGS. 1 and 3.

FIG. 3 is a functional block diagram showing an example of a display processing device 1 of this embodiment. The display processing device 1 of this embodiment shown in FIG. 3 has a storage unit 10, a viewing information output unit 20, an output viewing information identification unit 30, an identifier determination unit 40, and an identifier output unit 50. Hereinafter, the configuration of each unit will be described in detail.

The storage unit 10 can store the identifiers in association with a plurality of the pieces of viewing information to be output to the screen. In this embodiment, the storage unit 10 can store the identifiers in association with a plurality of pieces of the viewing information to be output to the portal screen. The storage unit 10 stores a plurality of pieces of the viewing information in association with at least one identifier. The storage unit 10 may store one piece of viewing information in association with each identifier.

A unit which realizes the configuration of the storage unit 10 is not particularly limited, and for example, the storage unit 10 may hold a table (hereinafter, referred to as “first table”) in which the identifiers are associated with at least one of a plurality of pieces of the viewing information to be output to the portal screen. As an example of the first table, a configuration shown in FIG. 2 may be provided. In this embodiment, it is assumed that the storage unit 10 holds the first table shown in FIG. 2.

The “viewing information to the output to the screen” corresponds to all kinds of information to be output to the screen intended to be viewed by the user. The number of pieces of the viewing information and the details are not particularly limited. In this embodiment, information which can be collected by the data center operation and maintenance application and output to the portal screen corresponds to viewing information.

For example, in this embodiment, viewing information can be “information representing overall service availability of the data center”, “information displaying a list of occurred failure (state of failure, details of failure, area, date and time, and the like)”, “map view (service availability of each division, operation cost, failure information, and the like are arranged on a map)”, “important service list (displaying service availability of important services, and the like)”, and the like. The illustration of the viewing information is just an example, and the viewing information of this embodiment may include one or more pieces of illustrated information or may include other pieces of information. Naturally, if the details of the applications differ, the details of the viewing information differ.

The identifiers are information for identifying a plurality of arbitrary combinations of viewing information, and can be aggregates of characters, numerals, symbols, or the like. The combinations of the viewing information can be arbitrarily determined. That is, the number of pieces of the viewing information in one combination is not particularly limited, and one piece of viewing information may be included in a plurality of combinations in an overlapping manner. In this embodiment, it is assumed that the combinations of the viewing information are combinations of a plurality of pieces of the viewing information which are viewed simultaneously when the user performs one task.

The identifiers for identifying the combinations may be aggregates of meaningless characters, numerals, symbols, or the like (for example: identifiers in which numerals are randomly arranged or the like) or may be aggregates of meaningful characters, numerals, symbols, or the like. When aggregates of meaningful characters, numerals, symbols, or the like are used, information for recognizing combinations of associated viewing information or information for recognizing the details of tasks which are performed while viewing the viewing information associated with the identifiers is preferably used.

For example, in the case of a combination of viewing information “information representing overall service availability” and “map view (service availability of each division, operation cost, failure information, and the like are arranged on a map)”, it is considered that the user performs a task to recognize the whole image of service availability while viewing the viewing information. Accordingly, the identifier which is associated with the combination may be “service availability confirmation” or the like.

In the case of a combination of viewing information “information displaying a list of occurred failure (state of failure, details of failure, area, date and time, and the like)” and “map view (service availability of each division, operation cost, failure information, and the like are arranged on a map)”, it is considered that the user performs a task to recognize the whole image of a service failure state while viewing the viewing information. Accordingly, the identifier which is associated with the combination may be “failure state confirmation” or the like.

With this, the user can easily recognize, from the meaning of the identifier, which viewing information is combined in the combination of viewing information associated with the identifier, which task which will be performed, or the like.

Information held by the storage unit 10, for example, the first table may be configured so as to be edited by the user. Although processing in which the user edits information stored in the storage unit 10 can be realized according to the technique of the related art, an example will be described in the following embodiments.

The viewing information output unit 20 outputs the viewing information to the screen. In this embodiment, the viewing information output unit 20 outputs the viewing information to the portal screen. The viewing information output unit 20 is configured to output a plurality of pieces of the viewing information to the screen simultaneously. For example, the viewing information output unit 20 is configured to output a plurality of windows or human interface (HI) components to the portal screen simultaneously and displays one piece of viewing information in one window or HI component, thereby realizing a configuration in which a plurality of pieces of the viewing information are output to the portal screen simultaneously. A display device, such as a display, which outputs the viewing information may be provided in the display processing device 1 or may not be provided in the display processing device 1. When the display processing device 1 does not have the display device, the display processing device 1 is connected to the display device in a wired or wireless manner, and the viewing information output unit 20 outputs the viewing information to the display of the display device.

A unit which acquires the viewing information output from the viewing information output unit 20 to the portal screen is not particularly limited, and may be made in various ways. For example, the viewing information may be stored in a memory of the display processing device 1, and the viewing information output unit 20 may acquire the viewing information from the memory and output the viewing information to the portal screen. The display processing device 1 may be configured to perform communication with an external device, which stores the viewing information, in a wired or wireless manner, and the viewing information output unit 20 may acquire the viewing information from the external device and may output the viewing information to the portal screen. The display processing device 1 may be configured to perform communication with an external device, which stores measurement data as a part of the viewing information, in a wired or wireless manner, and the viewing information output unit 20 may acquire measurement data from the external device through real time processing and/or batch processing, may arrange measurement data at a predetermined position of template data acquired from the memory of the display processing device 1, and may output measurement data to the portal screen.

The output viewing information identification unit 30 identifies the viewing information being output to the screen. In this embodiment, the output viewing information identification unit 30 identifies the viewing information output to the portal screen. For example, in the case of the portal screen shown in FIG. 1(a), the output viewing information identification unit 30 identifies viewing information V, W, X, and Y as the viewing information output to the portal screen. In the case of the portal screen shown in FIG. 1(b), the output viewing information identification unit 30 identifies viewing information V, W, X, Y, and Z as the viewing information output to the portal screen.

A unit which realizes the identification in the output viewing information identification unit 30 is not particularly limited, and may be realized by acquiring information for identifying the viewing information being output from the viewing information output unit 20, which outputs predetermined viewing information to the portal screen, to the portal screen.

The identifier determination unit 40 references the storage unit 10 and determines an identifier to be output to the screen on the basis of the viewing information identified by the output viewing information identification unit 30. In this embodiment, the identifier determination unit 40 references the first table (see FIG. 2) and determines the identifier to be output to the portal screen.

In this embodiment, the identifier determination unit 40 determines identifiers (hereinafter, referred to as “first identifiers”) as the identifier to be output to the screen. All the viewing information associated with the first identifier is included among at least one piece of viewing information identified by the output viewing information identification unit 30.

Specifically, in the case of a portal screen shown in FIG. 1(a), the output viewing information identification unit 30 identifies the viewing information V, W, X, and Y as the viewing information output to the portal screen, and notifies the identifier determination unit 40 of the relevant information. When this happens, the identifier determination unit 40 references the first table (see FIG. 2) and determines the first identifiers including all pieces of associated viewing information among viewing information V, W, X, and Y, that is, the identifiers “Task_A1” and “Task_A2” as the identifier to be output to the portal screen.

In the case of the portal screen shown in FIG. 1(b), the output viewing information identification unit 30 identifies the viewing information V, W, X, Y, and Z as the viewing information output to the portal screen, and notifies the identifier determination unit 40 of the relevant information. When this happens, the identifier determination unit 40 references the first table (see FIG. 2) and determines the first identifiers including all pieces of associated viewing information among the viewing information V, W, X, Y, and Z, that is, identifiers “Task_A1”, “Task_A2”, and “Task_A3” as the identifier to be output to the screen.

The identifier output unit 50 outputs the identifiers (first identifiers) determined by the identifier determination unit 40 to the screen. In this embodiment, the identifier output unit 50 outputs the first identifiers to the portal screen.

For example, as in the portal screen shown in FIGS. 1(a) and 1(b), in a state where the viewing information output unit 20 outputs the viewing information to a first region of the portal screen, the identifier output unit 50 outputs the first identifier to a second region different from the first region of the portal screen.

The display processing device 1 of this embodiment can be realized by, for example, installing the following program on a computer.

A program which causes a computer to function as:

a storage unit which stores identifiers in association with a plurality of pieces of the viewing information to be output to a screen, at least one identifier is associated with a plurality of pieces of the viewing information;

a viewing information output unit which is configured to output a plurality of pieces of the viewing information to the screen simultaneously and outputs the viewing information to the screen;

an output viewing information identification unit which identifies the viewing information being output to the screen;

an identifier determination unit which references the storage unit and determines the identifier to be output to the screen on the basis of the viewing information identified by the output viewing information identification unit; and

an identifier output unit which outputs the identifier determined by the identifier determination unit to the screen.

Next, an example of the flow of processing of a display processing method which is realized by the display processing device 1 of this embodiment will be described with reference to FIGS. 1, 2, and 4.

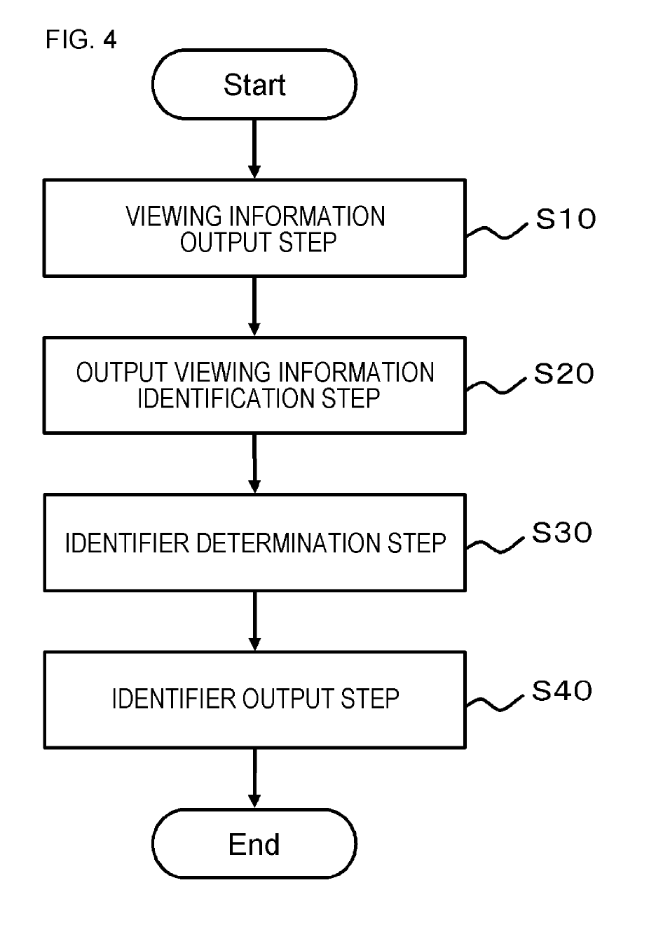

As shown in a flowchart of FIG. 4, a display processing method of this embodiment has a viewing information output step S10, an output viewing information identification step S20, an identifier determination step S30, and an identifier output step S40.

In the viewing information output step S10, the viewing information output unit 20 outputs at least one of a plurality of pieces of the viewing information to the portal screen in accordance with user operation.

For example, as shown in FIG. 1(a), the viewing information output unit 20 outputs the viewing information V, W, X, and Y to the portal screen.

In the output viewing information identification step S20, the output viewing information identification unit 30 identifies the viewing information output to the portal screen.

For example, in the case of the portal screen shown in FIG. 1(a), the output viewing information identification unit 30 identifies the viewing information V, W, X, and Y.

In the identifier determination step S30, the identifier determination unit 40 references the storage unit 10 and determines the identifier to be output to the portal screen on the basis of the viewing information identified in the output viewing information identification step S20.

In this example, the identifier determination unit 40 determines a first identifier as the identifier to be output to the screen. All the viewing information associated with the first identifier is included among at least one piece of viewing information identified in the output viewing information identification step S20.

For example, in the case of the portal screen shown in FIG. 1(a), the identifier determination unit 40 references the first table (see FIG. 2) and determines the identifier “Task_A1” associated with the viewing information X and Y and the identifier “Task_A2” associated with the viewing information V, W, and Y as the identifier to be output to the portal screen.

In the identifier output step S40, the identifier output unit 50 outputs the first identifiers as the identifiers determined in the identifier determination step S30 to the portal screen.

For example, as in the portal screen shown in FIG. 1(a), in a state where a plurality of pieces of the viewing information are output to the first region of the portal screen, the identifier output unit 50 outputs the identifiers “Task_A1” and “Task_A2” determined by the identifier determination unit 40 to the second region different from the first region of the portal screen.

Next, the functional effects of this embodiment will be described.

It is considered that the user who performs a predetermined task while viewing the screen to which a plurality of pieces of information are output simultaneously wants to easily recognize which task is associated with each piece of information output to the screen.

When tasks and information are associated with each other on a one-to-one basis, the user recognizes each piece of information output to the screen, thereby easily recognizing which task is associated with each piece of information output to the screen.

However, as described above, the user may perform predetermined tasks in various ways, for example, the user performs one task while alternately viewing a plurality of pieces of information output to the screen or performs two or more tasks in parallel while alternately viewing a plurality of pieces of information. A piece of information may be used in a plurality of tasks. That is, a plurality of pieces of information may be associated with one task, or a piece of information may be associated with a plurality of tasks. For this reason, there is a problem in that the user who faces the screen to which a plurality of pieces of information are output simultaneously can easily recognize which task is associated with each piece of information output to the screen.

According to the configuration of this embodiment, the above-described problem can be solved. That is, in the configuration of this embodiment, as shown in FIG. 2, for example, a combination of a plurality of pieces of information to be viewed simultaneously when performing one task is stored in advance in association with one identifier. As in the portal screen shown in FIGS. 1(a) and 1(b), in a state where a plurality of pieces of the viewing information are output to the portal screen simultaneously, the first identifiers including all pieces of associated viewing information among the plurality of pieces of the viewing information can be output to the portal screen.

According to the configuration of this embodiment, the user can recognize that there are all of a plurality of pieces of the viewing information to be viewed in order to perform a predetermined task among a plurality of pieces of the viewing information output to the portal screen on the basis of the fact that the first identifiers are output to the portal screen.

### Embodiment 2

A display processing device 1 of this embodiment has a configuration in which, if the viewing information output to the portal screen is changed in accordance with user operation, the identifiers output to the portal screen are accordingly changed, in addition to the configuration of the display processing device of Embodiment 1.

A functional block diagram which shows an example of the configuration of the display processing device 1 of this embodiment is the same as the functional block diagram (FIG. 3) which shows an example of the display processing device 1 of Embodiment 1. Hereinafter, the configuration of each unit will be described in detail. Description of the same configuration as in Embodiment 1 will not be repeated.

The viewing information output unit 20 changes the viewing information to be output to the screen in accordance with user operation. In this embodiment, the viewing information output unit 20 changes the viewing information to be output to the portal screen in accordance with user operation. A unit which receives an instruction input to change the viewing information to be output to the portal screen from the user is not particularly limited, and may be realized according to the technique of the related art.

If the viewing information to be output to the screen is changed, for example, the output viewing information identification unit 30 re-identifies the viewing information being output to the screen with the change as a trigger. In this embodiment, if the viewing information output to the portal screen is changed, for example, the output viewing information identification unit 30 re-identifies the viewing information output to the portal screen with the change as a trigger.

If the output viewing information identification unit 30 re-identifies the viewing information, for example, the identifier determination unit 40 references the storage unit 10 and re-determines the identifier to be output to the screen on the basis of the viewing information re-identified by the output viewing information identification unit 30 with the re-identification as a trigger. In this embodiment, if the output viewing information identification unit 30 re-identifies the viewing information, for example, the identifier determination unit 40 references the first table (see FIG. 2) and re-determines the identifier to be output to the portal screen on the basis of the viewing information re-identified by the output viewing information identification unit 30 with the re-identification as a trigger.

If the identifier determination unit 40 re-determines the identifier, for example, the identifier output unit 50 changes the identifier to be output to the screen to the first identifiers re-determined by the identifier determination unit 40 with the re-determination as a trigger. In this embodiment, if the identifier determination unit 40 re-determines the identifier, for example, the identifier output unit 50 changes the identifier to be output to the portal screen to the first identifiers re-determined by the identifier determination unit 40 with the re-determination as a trigger.

Hereinafter, an example of the flow of processing of a display processing method which is realized by the display processing device 1 of this embodiment will be described.

First, as in the portal screen shown in FIG. 1(a), if the instruction input to further output the viewing information Z is received from the user in a state where the viewing information V, W, X, and Y are output to the portal screen, as in the portal screen shown in FIG. 1(b), the viewing information output unit 20 further outputs the viewing information Z to the portal screen.

Next, in the state of the portal screen shown in FIG. 1(b) after the change, the output viewing information identification unit 30 identifies the viewing information V, W, X, Y, and Z output to the portal screen.

Next, the identifier determination unit 40 references the first table (see FIG. 2) and determines the first identifiers “Task_A1”, “Task_A2”, and “Task_A3”, which are the identifiers including all pieces of associated viewing information among the viewing information V, W, X, Y, and Z re-identified by the output viewing information identification unit 30, as the identifier to be output to the portal screen.

Next, the identifier output unit 50 changes the identifiers to be output to the portal screen from “Task_A1” and “Task_A2” to “Task_A1”, “Task_A2”, and “Task_A3”.

With the function of each unit, processing in which the viewing information to be output to the portal screen is changed in accordance with user operation and thus the identifiers to be output to the portal screen are changed is realized (FIG. 1(a)→FIG. 1(b)).

Next, an example of the flow of another processing of the display processing method which is realized by the display processing device 1 of this embodiment will be described.

First, as in the portal screen shown in FIG. 1(b), if an instruction input to stop the output of the viewing information Z (for example: an instruction input to close a window in which the viewing information Z is output) in a state where the viewing information V, W, X, Y, and Z are output to the portal screen, as in the portal screen shown in FIG. 1(a), the viewing information output unit 20 stops the output of the viewing information Z.

Next, in the state of the portal screen shown in FIG. 1(a) after the change, the output viewing information identification unit 30 identifies the viewing information V, W, X, and Y output to the portal screen.

Next, the identifier determination unit 40 references the first table (see FIG. 2) and determines the first identifiers “Task_A1” and “Task_A2”, which are the identifiers including all pieces of associated viewing information among the viewing information V, W, X, and Y re-identified by the output viewing information identification unit 30, as the identifier to be output to the portal screen.

Next, the identifier output unit 50 changes the identifier to be output to the portal screen from “Task_A1”, “Task_A2”, and “Task_A3” to “Task_A1” and “Task_A2”.

With the function of each unit, processing in which the viewing information to be output to the portal screen is changed in accordance with user operation and thus the identifiers to be output to the portal screen are changed is realized (FIG. 1(b)→FIG. 1(a)).

Hereinafter, the functional effects of this embodiment will be described.

In the configuration of this embodiment, if the viewing information to be output to the portal screen is changed, the identifiers to be output to the portal screen are accordingly changed automatically. According to the configuration of this embodiment, even when the viewing information to be output to the portal screen is changed, the user can easily recognize which task is associated with viewing information output among the viewing information after the change.

According to the configuration of this embodiment, the same functional effects of Embodiment 1 can be realized.

### Embodiment 3

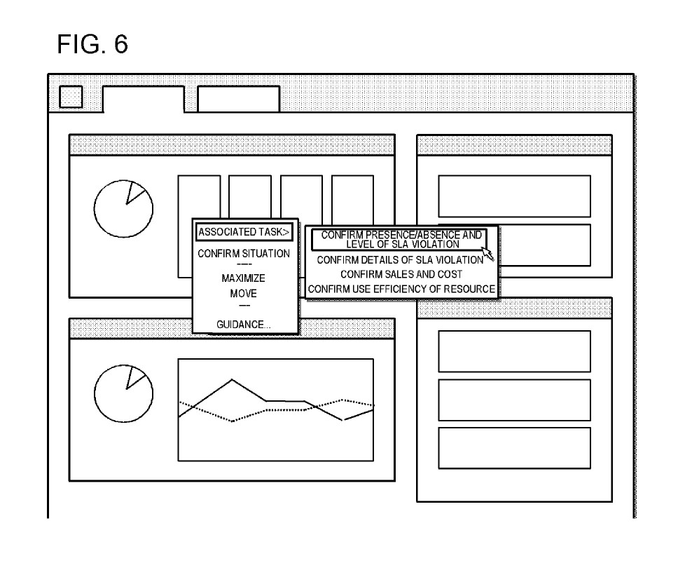

The configuration of a display processing device 1 of this embodiment is the same as in Embodiment 1 or 2, except that a method of outputting identifiers is different (see FIG. 6).

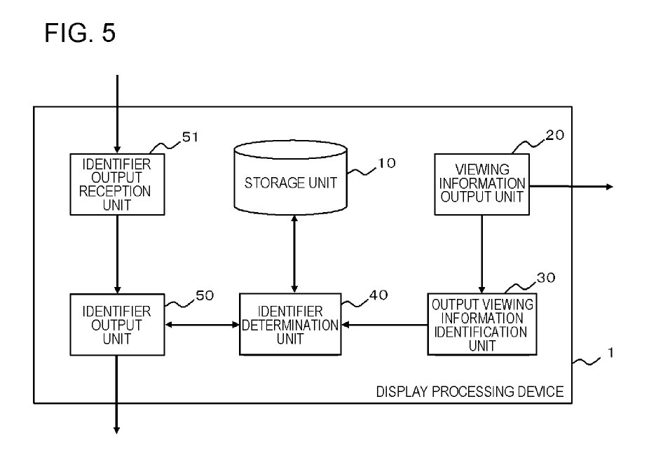

FIG. 5 is a functional block diagram showing an example of the configuration of the display processing device 1 of this embodiment. The display processing device 1 of this embodiment shown in FIG. 5 has a storage unit 10, a viewing information output unit 20, an output viewing information identification unit 30, an identifier determination unit 40, an identifier output unit 50, and an identifier output reception unit 51. Hereinafter, the configuration of each unit will be described in detail. Description of the same configuration as in Embodiment 1 or 2 will not be repeated.

The identifier output reception unit 51 receives an instruction input to output the identifiers in a state where the viewing information output unit 20 outputs the viewing information to the screen. In this embodiment, the identifier output reception unit 51 receives the instruction input to output the identifiers in a state where the viewing information output unit 20 outputs the viewing information to the portal screen. A unit which receives the instruction input in the identifier output reception unit 51 is not particularly limited, and may be realized according to various techniques of the related art.

If the identifier output reception unit 51 receives the instruction input, the identifier output unit 50 outputs the identifier (first identifier) determined by the identifier determination unit 40 to the screen with the reception of the input as a trigger in a state where the viewing information is output to the screen. In this embodiment, if the identifier output reception unit 51 receives the instruction input, the identifier output unit 50 outputs the first identifiers to the portal screen with the reception of the input as a trigger in a state where the viewing information is output to the portal screen.

For example, as in the portal screen shown in FIG. 6, if an input by clicking with a right button of a mouse is received in a state where a plurality of pieces of the viewing information are output to the portal screen, the identifier output unit 50 outputs a context menu shown in the drawing (in the drawing, a portrait context menu) to the portal screen. If a selection input of a predetermined menu (for example: “associated task” in the drawing) is received from the context menu, the identifier output unit 50 outputs the identifiers by a new context menu (in the drawing, a landscape context menu).

Each identifier shown in FIG. 6 is information for recognizing the details of a task to be performed while viewing the viewing information associated with the identifier. For example, the identifier “confirm presence/absence and level of service level agreement (SLA) violation” shown in FIG. 6 is associated with viewing information which is viewed simultaneously when performing a task to confirm the presence/absence and the level of SLA violation. The user can recognize the output of all pieces of the viewing information to be viewed simultaneously when performing the task among a plurality of pieces of the viewing information output to the portal screen on the basis of the fact that the relevant identifier is output.

According to the configuration of this embodiment, the same functional effects as in Embodiments 1 and 2 can be realized.

### Embodiment 4

A display processing device 1 of this embodiment has the following configuration in addition to the configuration of the display processing device 1 of any one of Embodiments 1 to 3.

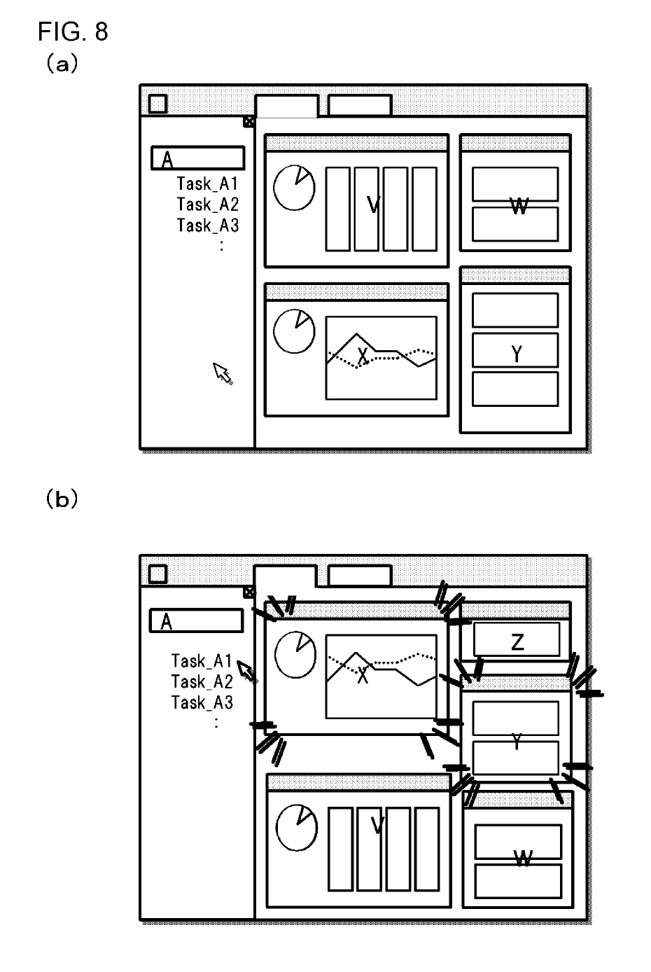

That is, for example, as shown in FIG. 8(b), the display processing device 1 of this embodiment receives an input to specify one (in FIG. 8(b), the first identifier “Task_A1”) of the first identifiers (“Task_A1” and the like) output to the portal screen. When this happens, the display processing device 1 of this embodiment outputs the viewing information such that the user can distinguish between the viewing information associated with the identifier and other pieces of the viewing information output to the portal screen. In FIG. 8(b), since the viewing information X and Y are associated with the first identifier “Task_A1”, only the viewing information X and Y are highlighted.

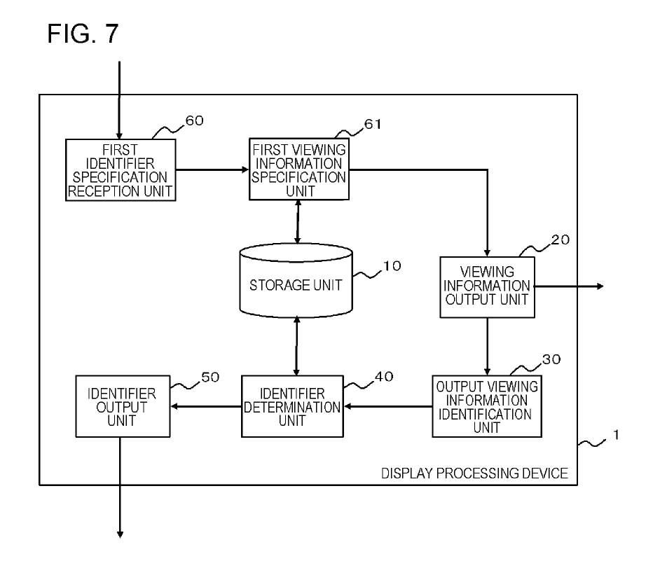

FIG. 7 is a functional block diagram showing an example of the configuration of the display processing device 1 of this embodiment. The display processing device 1 of this embodiment shown in FIG. 7 has a storage unit 10, a viewing information output unit 20, an output viewing information identification unit 30, an identifier determination unit 40, an identifier output unit 50, a first identifier specification reception unit 60, and a first viewing information specification unit 61. Hereinafter, the configuration of each unit will be described in detail. Description of the same configuration as in Embodiment 1, 2, or 3 will not be repeated.

The first identifier specification reception unit 60 receives an input to specify one of the first identifiers output from the identifier output unit 50. A unit which receives the input in the first identifier specification reception unit 60 is not particularly limited, and may be realized according to various techniques of the related art.

The first viewing information specification unit 61 references the storage unit 10 and specifies the viewing information associated with the first identifier received by the first identifier specification reception unit 60. In this embodiment, the first viewing information specification unit 61 references the first table (see FIG. 2) and specifies the viewing information associated with the first identifier received by the first identifier specification reception unit 60.

For example, as in the portal screen shown in FIG. 8(b), if the first identifier specification reception unit 60 receives an input (for example: alignment of the display position of a pointer with the display position of the identifier, alignment of the display position of a pointer with the display and clicking with a left button of a mouse, or the like) to specify the identifier “Task_A1”, the first viewing information specification unit 61 references the first table (see FIG. 2) and specifies the viewing information X and Y associated with the identifier “Task_A1”.

The viewing information output unit 20 outputs the viewing information such that the user can distinguish between the viewing information specified by the first viewing information specification unit 61 and other pieces of the viewing information being output. A unit which realizes the output is not particularly limited, and for example, the following means may be used.

For example, as in the portal screen shown in FIG. 8(b), if the first identifier specification reception unit 60 receives an input (for example: alignment of the display position of a pointer with the display position of the identifier, alignment of the display position of a pointer with the display position of the identifier and clicking with a left button of a mouse, or the like) to specify the identifier “Task_A1” from the state of the portal screen shown in FIG. 8(a), as in the portal screen shown in FIG. 8(b), the viewing information output unit 20 may flash only the viewing information (in the drawing, X and Y) specified by the first viewing information specification unit 61.

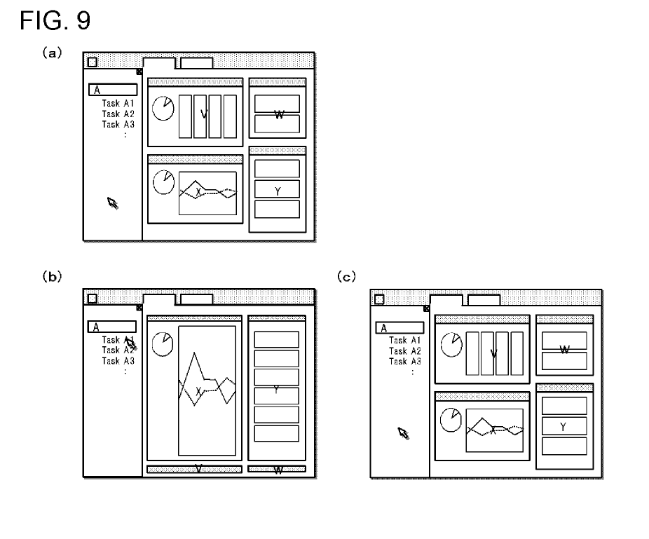

As another means, as in the portal screen shown in FIG. 9(b), if the first identifier specification reception unit 60 receives an input (for example: alignment of the display position of a pointer with the display position of the identifier) to specify the identifier “Task_A1” from the state of the portal screen shown in FIG. 9(a), as in the portal screen shown in FIG. 9(b), the viewing information output unit 20 may increase the display area of the viewing information (in the drawing, X and Y) specified by the first viewing information specification unit 61 and may make the display area of other pieces of the viewing information smaller than the display area of the specified viewing information. In the state of the portal screen shown in FIG. 9(b), if the specification of the identifier “Task_A1” is released (for example: shift of the display position of a pointer from the display position of the identifier), as in the portal screen shown in FIG. 9(c), the viewing information output unit 20 may return to the state before the specification of the identifier “Task_A1” (the same state as the portal screen shown in FIG. 9(a)).

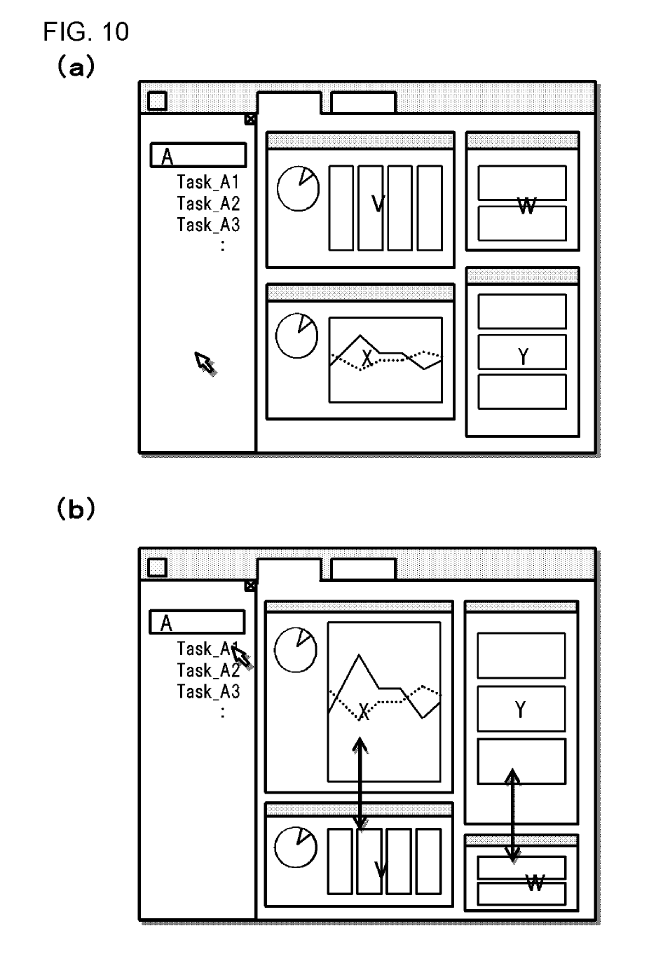

As another means, as in the portal screen shown in FIG. 10(b), if the first identifier specification reception unit 60 receives an input (for example: alignment of the display position of a pointer with the display position of the identifier, alignment of the display position of a pointer with the display position of the identifier and clicking with a left button of a mouse, or the like) to specify the identifier “Task_A1” from the state of the portal screen shown in FIG. 10(a), as in the portal screen shown in FIG. 10(b), the viewing information output unit 20 may output the viewing information (in the drawing, X and Y) specified by the first viewing information specification unit 61 above other pieces of the viewing information.

These means are just an example, and the viewing information output unit 20 may output the viewing information using other output means such that the user can distinguish between the viewing information specified by the first viewing information specification unit 61 and other pieces of the viewing information being output.

Hereinafter, the functional effects of this embodiment will be described.

According to the configuration of this embodiment, in a state where a plurality of pieces of the viewing information are output to the portal screen simultaneously, the first identifiers including all pieces of associated viewing information among a plurality of pieces of the viewing information can be output to the portal screen. In this embodiment, if an input to specify one of the output first identifiers is received, the viewing information can be output such that the user can distinguish between the viewing information associated with the identifier and other pieces of the viewing information being output.

According to the configuration of this embodiment, the user can easily recognize the viewing information associated with the first identifiers output to the portal screen. That is, it is possible to easily recognize viewing information to be viewed when performing a predetermined task.

According to the configuration of this embodiment, the same functional effects as in Embodiments 1 to 3 can be realized.

### Embodiment 5

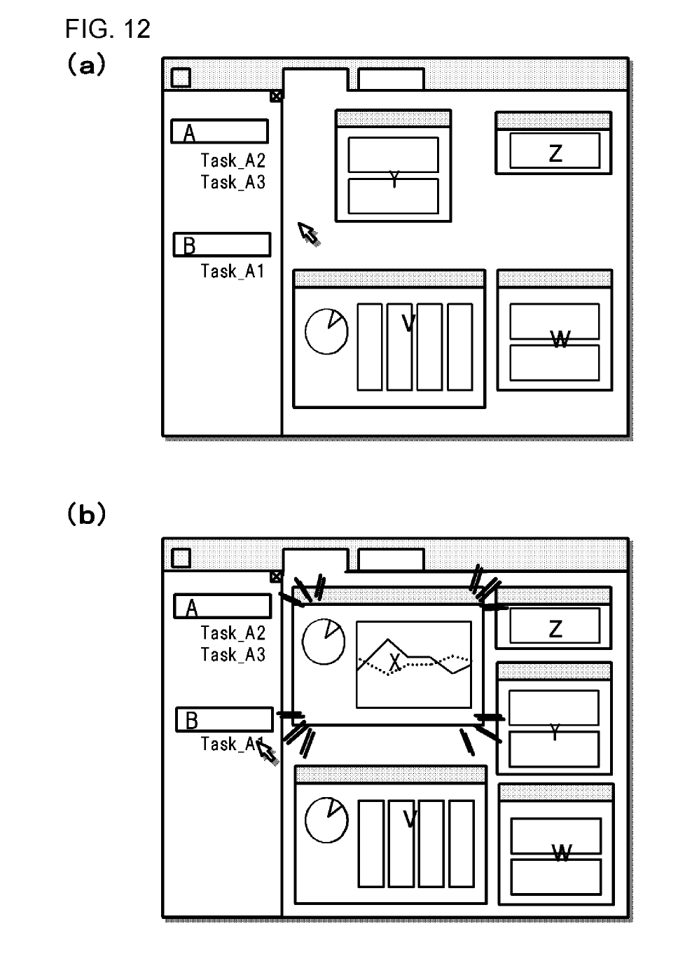

A display processing device 1 of this embodiment further has a configuration in which, for example, as in the portal screen shown in FIG. 12(a), second identifiers (in the case of the portal screen shown in FIG. 12(a), the identifier “Task_A1”) which are identifiers including at least one piece of associated viewing information and not including all pieces of the viewing information among the viewing information output to the portal screen are output, in addition to the configuration of the display processing device 1 of any one of Embodiments 1 to 4.

As in the portal screen shown in FIG. 12(a), the display processing device 1 of this embodiment may output the first identifiers (in the portal screen of FIG. 12(a), the identifiers “Task_A2” and “Task_A3”) to the portal screen, in addition to the second identifiers. In this case, the display processing device 1 outputs the first identifiers and the second identifiers such that the user can distinguish between the first identifiers and the second identifiers.

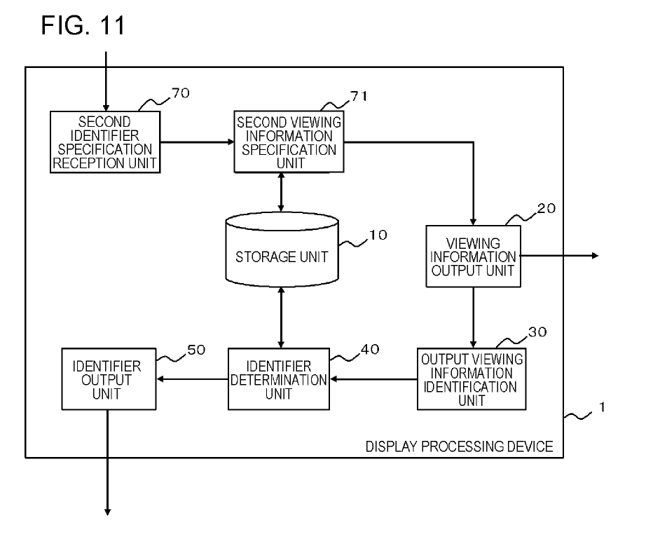

FIG. 11 is a functional block diagram showing an example of the configuration of the display processing device 1 of this embodiment. The display processing device 1 of this embodiment shown in FIG. 11 has a storage unit 10, a viewing information output unit 20, an output viewing information identification unit 30, an identifier determination unit 40, an identifier output unit 50, a second identifier specification reception unit 70, and a second viewing information specification unit 71. Hereinafter, the configuration of each unit will be described in detail. Description of the same configuration as in Embodiment 1, 2, 3, or 4 will not be repeated.

The identifier determination unit 40 determines the second identifiers as the identifier to be output to the screen. At least one piece of the viewing information associated with the second identifier is included among at least one piece of viewing information identified by the output viewing information identification unit 30. And not all the viewing information associated with the second identifier is included among at least one piece of viewing information identified by the output viewing information identification unit 30. In this embodiment, the identifier determination unit 40 references the first table (see FIG. 2) and determines the above-described second identifiers as the identifier to be output to the portal screen.

For example, in the case of the portal screen shown in FIG. 12(a), the identifier determination unit 40 references the first table (see FIG. 2) and determines the second identifiers including at least one piece of associated viewing information and not including all pieces of associated viewing information among viewing information V, W, Y, and Z, that is, the identifier “Task_A1” as the identifier to be output to the portal screen.

The identifier output unit 50 outputs the second identifiers determined by the identifier determination unit 40 to the screen. In this embodiment, the identifier output unit 50 outputs the second identifiers to the portal screen. As in the portal screen shown in FIG. 12(a), the identifier output unit 50 may output the first identifiers and the second identifiers to the portal screen simultaneously, or may output only the second identifiers to the screen without outputting the first identifiers. When the first identifiers and the second identifiers are output to the portal screen simultaneously, the identifier output unit 50 outputs the first identifiers and the second identifiers such that the user can distinguish between the first identifier and the second identifiers. A unit which outputs the first identifiers and the second identifiers such that the user can distinguish between the first identifiers and the second identifiers is not particularly limited, and for example, as shown in FIGS. 12(a) and 12(b), regions to which the first identifiers and the second identifiers are respectively output may be divided, or the display colors of the first identifiers and the second identifiers may be changed.

The second identifier specification reception unit 70 receives an input to specify one of the second identifiers output from the identifier output unit 50. A unit which receives the input in the second identifier specification reception unit 70 is not particularly limited, and may be realized according to various techniques of the related art.

The second viewing information specification unit 71 references the storage unit 10 and specifies the viewing information associated with the second identifier received by the second identifier specification reception unit 70. In this embodiment, the second viewing information specification unit 71 references the first table (see FIG. 2) and specifies the viewing information associated with the second identifier received by the second identifier specification reception unit 70.

For example, as in the portal screen shown in FIG. 12(b), if the second identifier specification reception unit 70 receives an input (for example: alignment of the display position of a pointer with the display position of the identifier, alignment of the display position of a pointer with the display position of the identifier and clicking with a left button of a mouse, or the like) to specify the identifier “Task_A1”, the second viewing information specification unit 71 references the first table shown in FIG. 2 and specifies the viewing information X and Y associated with the identifier “Task_A1”.

The viewing information output unit 20 further outputs viewing information not output to the screen among the viewing information specified by the second viewing information specification unit 71 to the screen. In this embodiment, the viewing information output unit 20 further outputs viewing information not output to the portal screen among the viewing information specified by the second viewing information specification unit 71 to the portal screen.

For example, in the state of the portal screen shown in FIG. 12(a), if the second viewing information specification unit 71 receives an input to specify the second identifier “Task_A1”, as in the portal screen shown in FIG. 12(b), the viewing information output unit 20 further outputs the viewing information X not output to the portal screen among the viewing information X and Y associated with the identifier “Task_A1” to the portal screen. With the change in the output of the viewing information, the identifier output unit 50 may erase the identifier “Task_A1” in the region to which the second identifiers are output, and may newly output the identifier “Task_A1” to the region to which the first identifiers are output.

Hereinafter, the functional effects of this embodiment will be described.

According to the configuration of this embodiment, in a state where a plurality of pieces of the viewing information are output to the portal screen simultaneously, the second identifiers including at least one piece of associated viewing information and not including all pieces of associated viewing information among the viewing information output to the portal screen can be output to the portal screen.

According to the configuration of this embodiment, in a state where only part of viewing information to be viewed when performing one task is output, the identifiers for recognizing the details of the task can be output. In this case, the user can recognize the output of only part of the viewing information associated with the task among a plurality of pieces of the viewing information output to the portal screen on the basis of the fact that the second identifiers are output.

According to the configuration of this embodiment, if an input to specify any one of the second identifiers is received from the user, all pieces of the viewing information associated with the second identifier can be output to the portal screen.

According to this configuration, the user performs an input to specify the second identifier, thereby outputting all pieces of the viewing information to be viewed when performing a predetermined task to the portal screen. Then, the user can start the predetermined task.

According to the configuration of this embodiment, the same functional effects as in Embodiments 1 to 4 can be realized.

### Embodiment 6

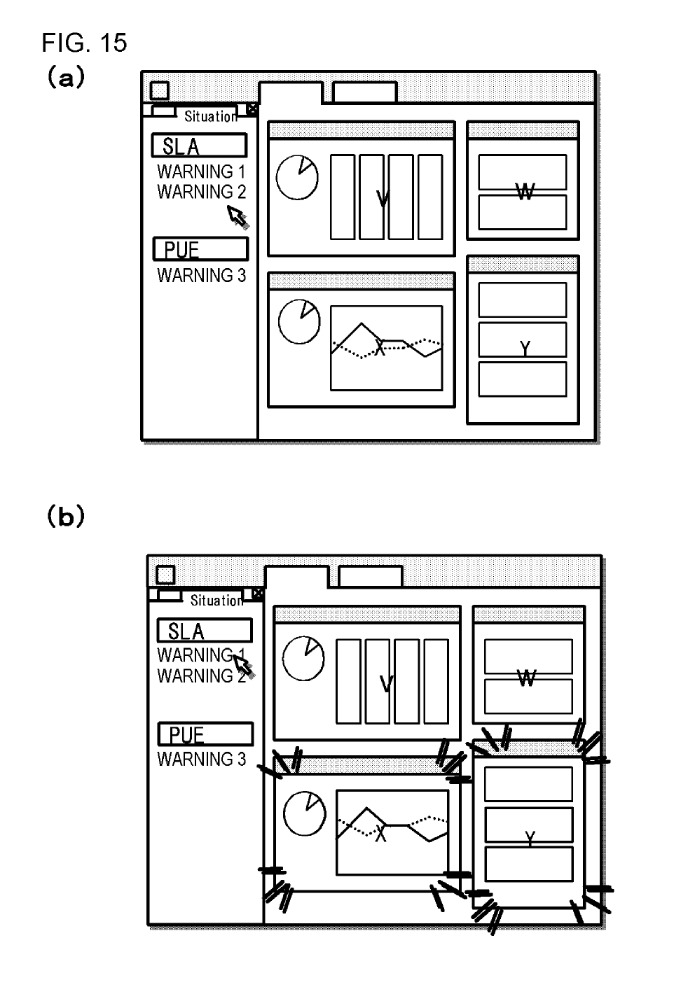

A display processing device 1 of this embodiment further has a configuration in which predetermined analysis is performed using data in at least one piece of viewing information among the viewing information output to the portal screen, and for example, as in the portal screen shown in FIGS. 15(a) and 15(b), the analysis results (in FIG. 15, “warning 1” and the like) are output to the portal screen, in addition to the configuration of the display processing device 1 of any one of Embodiments 1 to 5.

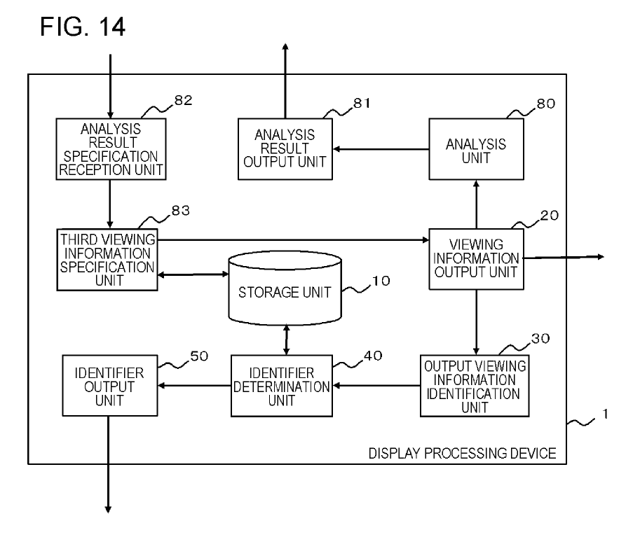

FIG. 14 is a functional block diagram showing an example of the configuration of the display processing device 1 of this embodiment. The display processing device 1 of this embodiment shown in FIG. 14 has a storage unit 10, a viewing information output unit 20, an output viewing information identification unit 30, an identifier determination unit 40, an identifier output unit 50, an analysis unit 80, an analysis result output unit 81, an analysis result specification reception unit 82, and a third viewing information specification unit 83. Hereinafter, the configuration of each unit will be described in detail. Description of the same configuration as in Embodiment 1, 2, 3, 4, or 5 will not be repeated.

The analysis unit 80 performs predetermined analysis using data in at least one piece of viewing information among the viewing information output from the viewing information output unit 20. Predetermined analysis which is performed using data in the viewing information is not particularly limited, and for example, analysis for monitoring whether or not SLA violation occurs may be performed or analysis for monitoring whether or not predetermined data (measurement data) in the viewing information exceeds a predetermined threshold value may be performed. An algorithm for performing the analysis is a design matter. The analysis unit 80 may perform a plurality of kinds of analysis in parallel. As the result of analysis, when it is determined that a situation in which a warning should be given to the user occurs, the analysis unit 80 notifies the analysis result output unit 81 described below of information indicating this effect. Although a case where “a situation in which a warning should be given to the user occurs” is a design matter, for example, a case where SLA violation occurs may be a case where predetermined measurement data exceeds a predetermined threshold value, or the like.

The analysis result output unit 81 outputs the analysis results of the analysis unit 80 to the screen. In this embodiment, the analysis result output unit 81 outputs the analysis results of the analysis unit 80 to the portal screen.

For example, if information indicating that a situation in which a warning should be given to the user occurs is received from the analysis unit 80, the analysis result output unit 81 outputs information indicating this effect to the portal screen as the analysis results. For example, as in the portal screen shown in FIGS. 15(a) and 15(b), the analysis result output unit 81 may output information, such as “warning 1” and “warning 2”, as information indicating the summaries of the analysis results to the portal screen. If an input (for example: alignment of the display position of a pointer with the display position of the identifier, alignment of the display position of a pointer with the display and clicking with a left button of a mouse, or the like) to specify the information (for example: “warning 1”) is received from the user, the analysis result output unit 81 may output the detailed analysis result to the portal screen. The output means may be realized according to the technique of the related art.

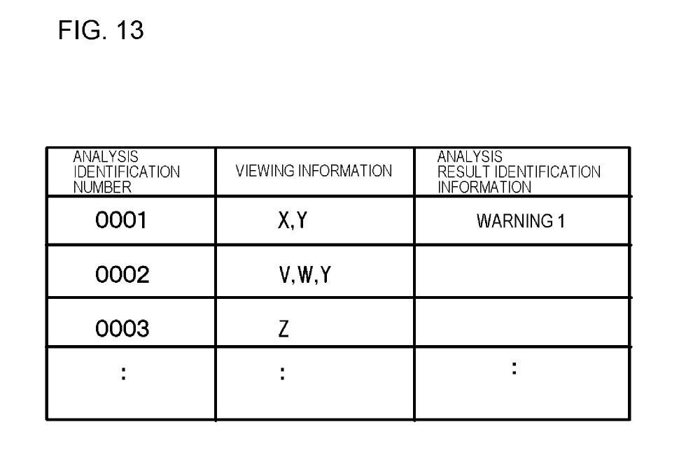

The storage unit 10 stores the analysis result output from the analysis result output unit 81 in association with at least one piece of viewing information used to obtain the analysis result. A unit which realizes the configuration of the storage unit 10 is not particularly limited, and the storage unit 10 may hold a table (hereinafter, referred to as “second table”) in which the analysis result output from the analysis result output unit 81 and at least one piece of viewing information used to obtain the analysis result are associated with each other. FIG. 13 schematically shows an example of the second table. In this embodiment, it is assumed that the storage unit 10 holds the second table shown in FIG. 13.

For example, the storage unit 10 stores identification information (in FIG. 13, “analysis identification number”) for identifying analysis (for example: analysis for monitoring whether or not SLA violation occurs, analysis for monitoring whether or not predetermined data (measurement data) in the viewing information exceeds a predetermined threshold value, or the like) in the analysis unit 80 in association with at least one piece of viewing information used for the analysis in advance. The analysis result output unit 81 receives, from the analysis unit 80, information indicating that a situation in which a warning should be given to the user occurs, and when outputting the analysis result to the portal screen, information (in FIG. 13, “analysis result identification information”) for identifying the analysis result is stored in association with identification information (in FIG. 13, “analysis identification number”) for identifying the analysis.

The analysis result specification reception unit 82 receives an input to specify one of the analysis results output from the analysis result output unit 81. A unit which receives the input in the analysis result specification reception unit 82 is not particularly limited, and may be realized according to various techniques of the related art.

The third viewing information specification unit 83 references the storage unit 10 and specifies the viewing information associated with the analysis result received by the analysis result specification reception unit 82. In this embodiment, the third viewing information specification unit 83 references the second table and specifies the viewing information associated with the analysis result received by the analysis result specification reception unit 82.

For example, as in the portal screen shown in FIG. 15(b), if the analysis result specification reception unit 82 receives an input (for example: alignment of the display position of a pointer with the display position of the analysis result, alignment of the display position of a pointer with the display position of the analysis result and clicking with a left button of a mouse, or the like) to specify the analysis result “warning 1”, the third viewing information specification unit 83 references the second table shown in FIG. 13 and specifies the viewing information X and Y associated with the analysis result “warning 1”.

The viewing information output unit 20 outputs the viewing information such that the user can distinguish between the viewing information specified by the third viewing information specification unit 83 and other pieces of the viewing information being output. A unit which outputs the viewing information distinguishably is not particularly limited, and for example, as in the portal screen shown in FIG. 15(b), only the viewing information (in the drawing, X and Y) specified by the third viewing information specification unit 83 may be flashed. The means in Embodiment 4 described with reference to FIGS. 9 and 10 may be used.

Hereinafter, the functional effects of this embodiment will be described.

According to the configuration of this embodiment, in a state where a plurality of pieces of the viewing information are output to the portal screen simultaneously, predetermined analysis can be performed using data in at least one piece of the viewing information, and the analysis results can be output. According to the configuration of this embodiment, if an input to specify one of the analysis results output to the portal screen is received, the viewing information can be output such that the user can distinguish between the viewing information used for the analysis and other pieces of the viewing information being output.

According to the configuration of this embodiment, the user can recognize the outline of a situation to be recognized from the viewing information output to the portal screen on the basis of the analysis results output to the portal screen. When examining the analysis results in more detail, the user performs an input to specify one of the analysis results output to the portal screen, and outputs the viewing information such that the viewing information used for the analysis and other pieces of the viewing information being output can be distinguished from each other, thereby easily recognizing the viewing information to be viewed.

According to this embodiment, the same functional effects as in Embodiments 1 to 5 can be realized.

### Embodiment 7

A display processing device 1 of this embodiment further has a configuration in which the user can edit information (for example: see FIG. 2) in which the identifiers and the viewing information stored in the storage unit 10 are associated with each other, in addition to the configuration of the display processing device 1 of any one of Embodiments 1 to 6.

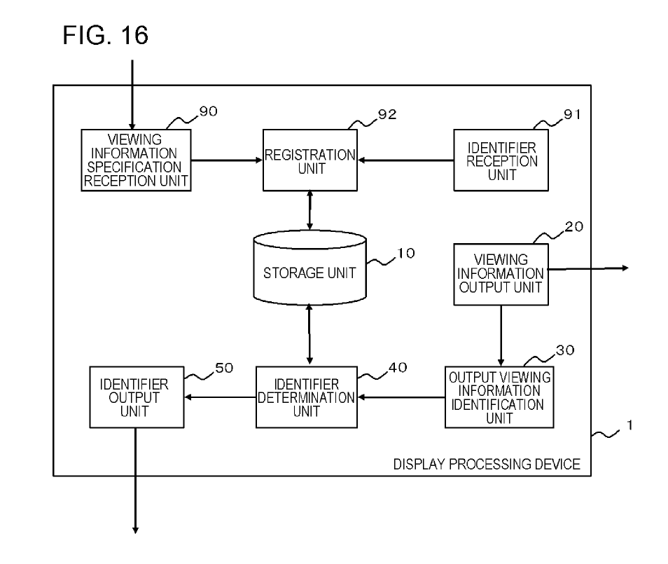

FIG. 16 is a functional block diagram showing an example of the configuration of the display processing device 1 of this embodiment. The display processing device 1 of this embodiment shown in FIG. 16 has a storage unit 10, a viewing information output unit 20, an output viewing information identification unit 30, an identifier determination unit 40, an identifier output unit 50, a viewing information specification reception unit 90, an identifier reception unit 91, and a registration unit 92. The display processing device 1 of this embodiment may have a configuration in which the identifier reception unit 91 is not provided. Hereinafter, the configuration of each unit will be described in detail. Description of the same configuration as in Embodiment 1, 2, 3, 4, 5, or 6 will not be repeated.

The viewing information specification reception unit 90 receives an input to specify at least one of a plurality of pieces of the viewing information to be output to the screen. In this embodiment, the viewing information specification reception unit 90 receives an input to specify at least one of a plurality of pieces of the viewing information to be output to the portal screen.

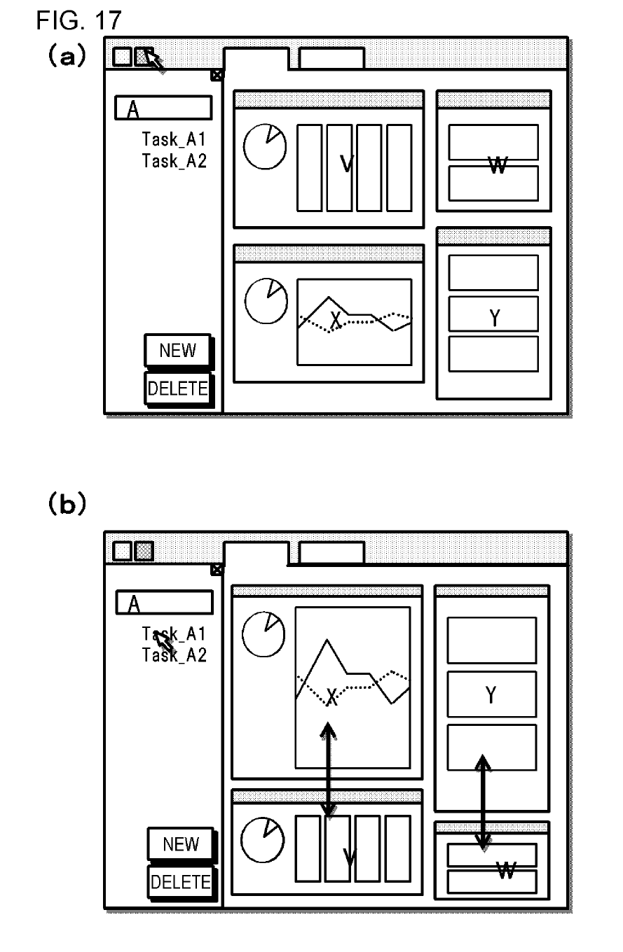

For example, as in the portal screen shown in FIG. 17(a), in a state where the viewing information output unit 20 outputs at least one piece of viewing information to the portal screen, the viewing information specification reception unit 90 may receive an input to specify at least one piece of viewing information among the viewing information output to the portal screen. A unit which receives the input in the viewing information specification reception unit 90 is not particularly limited, and may be realized according to various techniques of the related art.

The registration unit 92 receives an instruction input to store the identifiers in the storage unit 10 in association with at least one piece of viewing information received by the viewing information specification reception unit 90. When this happens, the registration unit 92 stores the identifiers in the storage unit 10 in association with at least one piece of the viewing information received by the viewing information specification reception unit 90. The identifiers to be stored may be determined automatically by a computer in accordance with a rule defined in advance, or the identifiers input from the user and received by the identifier reception unit 91 shown in FIG. 16 may be used. A unit which receives the input in the identifier reception unit 91 is not particularly limited, and may be realized according to various techniques of the related art.

Hereinafter, a processing example of this embodiment where the user edits information (for example: see FIG. 2) in which the identifiers and the viewing information stored in the storage unit 10 are associated with each other will be described.

### Example 1

### FIG. 17

In this example, the display processing device 1 has the first identifier specification reception unit 60 and the first viewing information specification unit 61, in addition to the respective units shown in FIG. 16.

First, the display processing device 1 activates an edition mode in accordance with user input (FIG. 17(a)). The user can customize the viewing information (in FIG. 17(a), viewing information V, W, X, and Y) output to the portal screen. As in the foregoing embodiment, the identifier output unit 50 outputs the first identifiers to the portal screen.

In the portal screen, as in the portal screen shown in FIG. 17(b), if the first identifier specification reception unit 60 receives an input to specify one of the first identifiers output to the portal screen from the user (in FIG. 17(b), receives an input to specify the first identifier “Task_A1”), the first viewing information specification unit 61 references the first table (see FIG. 2) and specifies the viewing information associated with the first identifier. When this happens, the identifier output unit 50 outputs the viewing information such that the user can distinguish between the viewing information specified by the first viewing information specification unit 61 and other pieces of the viewing information output to the portal screen. For example, as in the portal screen shown in FIG. 17(b), the first viewing information specification unit 61 outputs the specified viewing information above other pieces of the viewing information.

Through the above processing, the user can recognize one or more pieces of the viewing information associated with the specified first identifier. The following processing can be performed in accordance with the recognized details.

<Edition of Identifiers Stored in Storage Unit 10>

The display processing device 1 receives an input (for example: alignment of the display position of a pointer with the display position of the first identifier and clicking with a right button of a mouse, or the like) to start edition of the first identifier from the user, and thereafter, receives an input of the edition details. For example, the display processing device 1 receives an input to change the identifier from “Task_A1” to “confirm presence/absence and level of SLA violation” from the user. The display processing device 1 updates the details of the first table (see FIG. 2) in accordance with the input edition details. A unit which receives the input of the edition details in the display processing device 1 is not particularly limited, and may be realized according to various techniques of the related art.

Although in the above description, an example is shown where the first identifiers output to an edition screen shown in FIGS. 17(a) and 17(b) are directly operated and edited has been described, another window may be called, and edition may be performed on this window.

<Deletion of Identifiers Stored in Storage Unit 10>

The display processing device 1 receives an input (for example: alignment of the display position of a pointer with the display position of the first identifier and clicking with a left button of a mouse, or the like) to specify one or more first identifiers, and thereafter, receives an input (for example: alignment of the display position of a pointer with the display position of a button “delete”, or the like) to delete the specified identifiers. The display processing device 1 deletes the combinations of the specified identifiers and the viewing information associated with the identifiers from the first table (see FIG. 2).

<Registration of New Identifier in Storage Unit 10>

The display processing device 1 receives an input (for example: alignment of the display position of a pointer with the display position of the viewing information and clicking with a left button of a mouse, or the like) to specify at least one piece of viewing information among the viewing information output to the portal screen, and thereafter, receives an input (for example: alignment of the display position of a pointer with the display position of a button “new” and clicking with a left button of a mouse, or the like) to newly register the combination of the specified viewing information. The display processing device 1 stores the combinations of the specified viewing information in the first table (see FIG. 2) in association with a new identifier. If an input (for example: alignment of the display position of a pointer with the display position of a button “new” and clicking with a left button of a mouse) to newly register the combination of the specified viewing information is received, the display processing device 1 may receive an input of an identifier (for example: “confirm presence/absence and level of SLA violation”) associated with the combination, and may store the identifier in the first table (see FIG. 2) in association with the combination of the specified viewing information.

### Example 2

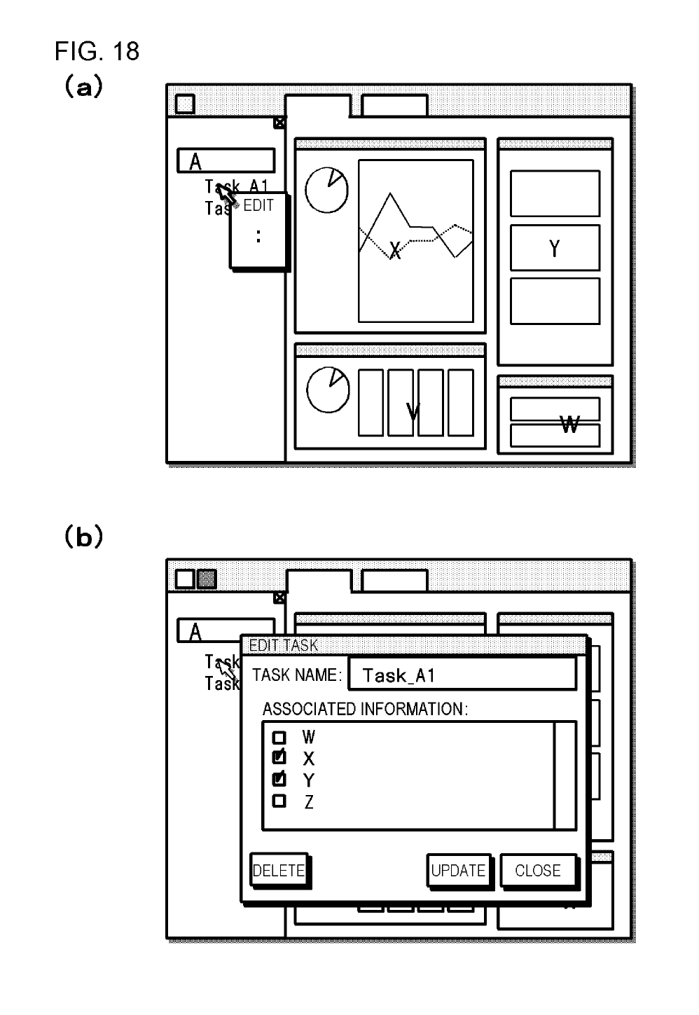

### FIG. 18

First, the display processing device 1 receives an input to start edition of the first identifier from the user. For example, as in the portal screen shown in FIG. 18(a), if an input by clicking with a right button of a mouse in a state where the display position of a pointer is aligned with the display position of a predetermined first identifier is received, the display processing device 1 outputs a context menu. The display processing device 1 receives a selection input of a predetermined menu (for example: “edit” in the drawing) from the output context menu, thereby receiving an input to start edition of the first identifier.

If an input to start edition of the first identifier is received from the user, as in the portal screen shown in FIG. 18(b), the display processing device 1 newly outputs an identifier edition window to the portal screen. In the identifier edition window, an identifier to be edited is displayed. In the identifier edition window, the viewing information output to the portal screen is displayed, and a checkbox corresponding to each piece of viewing information is displayed. A checkbox corresponding to the viewing information associated with the identifier to be edited at this time is checked.

In the identifier edition window, the user can perform an input to edit the identifier (for example: direct input to the column of a task name and clicking on an update button), an input (for example: changing of a check to the checkbox and clicking on the update button) to change the viewing information associated with the identifier, and an input (for example: clicking on the delete button) to delete the identifier.

Though not shown, in the state of the portal screen shown in FIG. 18(a), if an input by clicking with a right button of a mouse in a state where the display position of a point is not aligned with the display position of any first identifier is received, the display processing device 1 may output a context menu including a menu “create new”. If a selection input of “create new” is received, the display processing device 1 may output, as the identifier edition window shown in FIG. 18(b), a window in which any checkbox is not checked and a default identifier (for example: “new 1” or the like) is displayed as the identifier. A predetermined input may be received from the window, thereby receiving an input to register a new identifier in the storage unit 10.

In this example, the display processing device 1 may have the first identifier specification reception unit 60 and the first viewing information specification unit 61, in addition to the respective units shown in FIG. 16, and may realize the same functions as Example 1.

Hereinafter, the functional effects of this embodiment will be described.

According to the configuration of this embodiment, the user can edit information in which the identifiers and at least one of a plurality of pieces of the viewing information to be output to the portal screen stored in the storage unit are associated with each other. For example, the user can edit the first table (see FIG. 2) of this embodiment.

According to this embodiment, the same functional effects as in Embodiments 1 to 6 can be realized.

### Embodiment 8

A display processing device 1 of this embodiment further has the following configuration, in addition to the configuration of the display processing device 1 of any one of Embodiments 1 to 7.

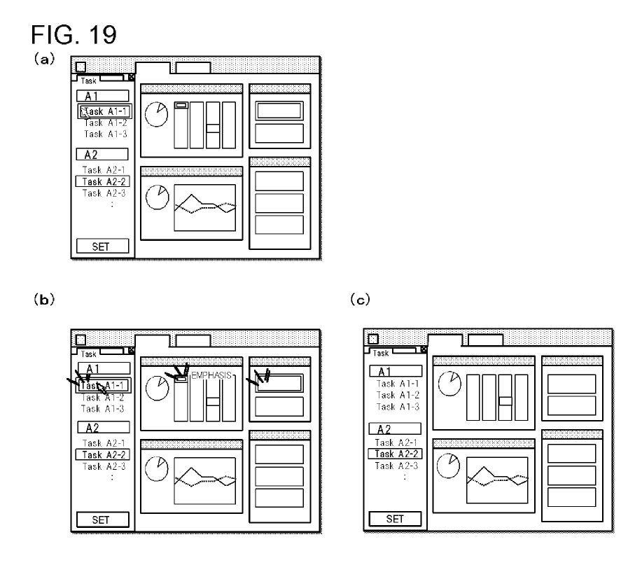

As in the portal screen shown in FIG. 19(a), if the details (for example: measurement data) of the viewing information output to the portal screen are updated, the display processing device 1 of this embodiment outputs the updated location such that the user can recognize updated location. A unit which outputs the updated location such that the user can recognize the updated location is not particularly limited, and in the portal screen shown in FIG. 19(a), the updated location is surrounded by a box-shaped single frame or a box-shaped double frame. In this way, a unit which identifies the updated location of the viewing information and outputs the updated location such that the user can recognize the updated location may be realized according to the technique of the related art.

If the details of the viewing information are updated, the display processing device 1 of this embodiment references the first table (see FIG. 2) and specifies the identifier associated with the viewing information.

The display processing device 1 outputs the specified identifier such that the user can distinguish between the specified identifier and other identifiers output to the portal screen. A unit which outputs the identifier and other identifiers such that the user can distinguish the identifier and other identifiers is not particularly limited, and in the portal screen shown in FIG. 19(a), the identifier is surrounded by a box-shaped single frame or a box-shaped double frame. In the portal screen shown in FIG. 19(a), processing for surrounding the identifier with a box-shaped single frame or a box-shaped double frame is the same as the processing on the updated location of the viewing information associated with the identifier.

As in the portal screen shown in FIG. 19(b), if an input to specify an identifier subjected to processing for surrounding with a box-shaped frame or the like is received (for example: alignment of the display position of a point with the display position of the identifier, or the like), the display processing device 1 of this embodiment references the first table (see FIG. 2) and specifies the viewing information associated with the identifier. The updated location is output such that the user can distinguish the updated location of the specified viewing information and the updated locations of other pieces of the viewing information. A unit which outputs the updated location such that the user can distinguish between the updated location of the viewing information and the updated locations of other pieces of the viewing information is not particularly limited, and in the portal screen shown in FIG. 19(a), the updated location of the viewing information is flashed.

As in the portal screen shown in FIG. 19(c), if an input to release the input to specify the identifier subjected to processing for surrounding with a box-shaped frame or the like is received (for example: shift of the display position of a pointer from the display position of the identifier, or the like), the display processing device 1 of this embodiment references the first table (see FIG. 2), specifies the viewing information associated with the identifier, stops output for allowing the user to recognize the update location of the viewing information, and stops output for allowing the user to identify the identifier.

According to this embodiment, a user-friendly interface can be realized. According to this embodiment, the same functional effects as in Embodiments 1 to 7 can be realized.

### Embodiment 9

A display processing device 1 of this embodiment can have the same configuration as the display processing device 1 of any one of Embodiments 1 to 8 excluding the following difference. That is, although the display processing device 1 of any one of Embodiments 1 to 8 outputs a plurality of pieces of information to the portal screen of a predetermined application simultaneously, the display processing device 1 of this embodiment has a difference in that viewing information provided by a plurality of applications are output simultaneously to a display screen (OS screen) which is realized by an OS controlling a plurality of applications.

The types of a plurality of applications are not particularly limited, and an application for document creation, an application for numerical calculation, an application for image edition, a database application, a Web browser, an electronic mail application, a financial accounting application, a personnel management application, an inventory management application, an application for observing predetermine data, or the like may be used. The illustration of the applications is just an example, and other applications may be included.

Hereinafter, the configuration of each unit constituting the display processing device 1 of this embodiment will be described in detail. Description of the same configuration as in Embodiment 1, 2, 3, 4, 5, 6, 7, or 8 will not be repeated.

The storage unit 10 stores identifiers in association with the file names and the file attributes of at least one piece of data among data output from an application which can output viewing information to the OS screen. The storage unit 10 may store the storage location of the file in association with each file name. The “file attribute of data” is information for identifying whether or not data is processed by either application.

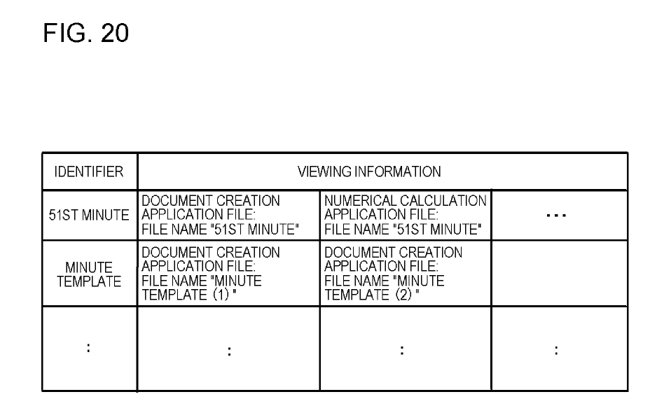

FIG. 20 schematically shows an example of a first table which is held by the storage unit of this embodiment. In the first table shown in FIG. 20, as viewing information, a “51st minute” file which is processed by an application for document creation and a “51st minute” file which is processed by an application for numerical calculation as viewing information are associated with an identifier “51st minute”. In the first table shown in FIG. 20, as viewing information, a “minute template (1)” file which is processed by an application for document creation and a “minute template (2)” file which is processed by an application for document creation are associated with an identifier “minute model”.

The above-described information stored in the storage unit 10, for example, the first table shown in FIG. 20 can be edited by the user.

The viewing information output unit 20 is configured to output a plurality of pieces of the viewing information to the OS screen simultaneously, and outputs the viewing information to the OS screen. For example, the viewing information output unit 20 is configured to output a plurality of windows or HI components to the OS screen simultaneously, and displays data (viewing information) of one file processed by one application in one window or HI component.

The output viewing information identification unit 30 identifies the viewing information output to the OS screen. That is, the output viewing information identification unit 30 identifies the file attributes and the file names of the viewing information output to the OS screen.

Other parts are the same as those in the foregoing embodiments.

Hereinafter, an example of the flow of processing of a display processing method which is realized by the display processing device 1 of this embodiment will be described.

First, the viewing information output unit 20 controls a predetermined application according to user operation, and outputs predetermined viewing information to the OS screen. For example, the viewing information output unit 20 controls an application for document creation, and output the “51st minute” file to the OS screen. The viewing information output unit 20 controls an application for numerical calculation, and outputs the “51st minute” file to the OS screen. A unit which receives an instruction input to output predetermined viewing information to the OS screen from the user is not particularly limited, and may be realized according to the technique of the related art.

Next, the output viewing information identification unit 30 identifies the viewing information output to the OS screen. In this embodiment, the output viewing information identification unit 30 identifies the file attributes and file names of the viewing information output to the OS screen. The relevant processing can be realized according to the technique of the related art.

Next, the identifier determination unit 40 references the first table (see FIG. 20), and determines the first identifier “51st minute” including all pieces of associated viewing information among the viewing information identified by the output viewing information identification unit 30 as the identifier to be output to the OS screen.

Next, the identifier output unit 50 outputs the first identifier “51st minute” to the OS screen.

An example where the display processing device 1 of this embodiment performs the same processing as display processing which is realized by the display processing device 1 of Embodiment 1 has been described. However, the display processing device 1 of the embodiment can perform the same display processing as in the display processing devices 1 of Embodiments 2 to 8 according to display processing which is realized by the display processing devices 1 of Embodiments 2 to 8.

According to this embodiment, the same functional effects as in Embodiments 1 to 8 can be realized.

This application claims priority based on Japanese Patent Application No. 2010-201781, filed Sep. 9, 2010, the entire disclosure of which is incorporated therein.

1. A display processing device comprising:
a storage unit which stores identifiers in association with a plurality of pieces of viewing information to be output to a screen, at least one identifier is associated with a plurality of pieces of the viewing information;
a viewing information output unit which is configured to output a plurality of pieces of the viewing information to the screen simultaneously and outputs the viewing information to the screen;
an output viewing information identification unit which identifies the viewing information being output to the screen;
an identifier determination unit which references the storage unit and determines an identifier to be output to the screen on the basis of the viewing information identified by the output viewing information identification unit; and
an identifier output unit which outputs the identifier determined by the identifier determination unit to the screen.

2. The display processing device according to claim 1,
wherein the identifier determination unit determines a first identifier as the identifier to be output to the screen, and all the viewing information associated with the first identifier is included among at least one piece of viewing information identified by the output viewing information identification unit.

3. The display processing device according to claim 2, further comprising:
a first identifier specification reception unit which receives an input to specify one of the first identifiers output from the identifier output unit; and
a first viewing information specification unit which references the storage unit and specifies the viewing information associated with the first identifier received by the first identifier specification reception unit,
wherein the viewing information output unit outputs the viewing information such that a user is able to distinguish between the viewing information specified by the first viewing information specification unit and other pieces of the viewing information being output.

4. The display processing device according to claim 1,
wherein the identifier determination unit determines a second identifier as the identifier to be output to the screen, and at least one piece of the viewing information associated with the second identifier is included among at least one piece of viewing information identified by the output viewing information identification unit, and not all the viewing information associated with the second identifier is included among at least one piece of viewing information identified by the output viewing information identification unit.

5. The display processing device according to claim 4, further comprising:
a second identifier specification reception unit which receives an input to specify one of the second identifiers output from the identifier output unit; and
a second viewing information specification unit which references the storage unit and specifies the viewing information associated with the second identifier received by the second identifier specification reception unit,
wherein the viewing information output unit further outputs the viewing information not being output to the screen among the viewing information specified by the second viewing information specification unit to the screen.

6. The display processing device according to claim 1, further comprising:
an analysis unit which performs a predetermined analysis using data included in at least one piece of viewing information among the viewing information output from the viewing information output unit; and
an analysis result output unit which outputs the analysis results of the analysis unit to the screen.

7. The display processing device according to claim 6,
wherein the storage unit further stores the analysis results output from the analysis result output unit in association with at least one piece of viewing information used to obtain the analysis results,
the display processing device further comprises:
an analysis result specification reception unit which receives an input to specify one of the analysis results output from the analysis result output unit; and
a third viewing information specification unit which references the storage unit and specifies the viewing information associated with the analysis result received by the analysis result specification reception unit, and
the viewing information output unit outputs the viewing information such that a user is able to distinguish between the viewing information specified by the third viewing information specification unit and other pieces of the viewing information being output.

8. The display processing device according to claim 1,
wherein the viewing information output unit is configured to output a plurality of windows to the screen simultaneously, and outputs one of the plurality of pieces of the viewing information to one of the plurality of windows.

9. The display processing device according to claim 1,
wherein the viewing information output unit outputs the viewing information to a first region of the screen, and
the identifier output unit outputs the identifier determined by the identifier determination unit to a second region different from the first region of the screen in a state where the viewing information is output to the first region.

10. The display processing device according to claim 9,
wherein the viewing information output unit changes the viewing information to be output to the screen in accordance with user operation,
if the viewing information to be output to the screen is changed, the output viewing information identification unit re-identifies the viewing information being output to the screen,
if the output viewing information identification unit re-identifies the viewing information, the identifier determination unit references the storage unit and re-determines the identifier to be output to the screen on the basis of the viewing information re-identified by the output viewing information identification unit, and
if the identifier determination unit re-determines the identifier, the identifier output unit changes the identifier to be output to the screen to the identifier re-determined by the identifier determination unit.

11. The display processing device according to claim 1, further comprising:
an identifier output reception unit which receives an instruction input to output the identifier in a state where the viewing information output unit outputs the viewing information to the screen,
wherein, if the identifier output reception unit receives the instruction input, the identifier output unit outputs the identifier determined by the identifier determination unit with the reception of the input as a trigger in a state where the viewing information is output to the screen.

12. The display processing device according to claim 1, further comprising:
a viewing information specification reception unit which receives an input to specify at least one of the viewing information to be output to the screen; and
a registration unit which, if an instruction input to store the identifier in the storage unit in association with at least one piece of viewing information received by the viewing information specification reception unit is received, stores the identifier in the storage unit in association with at least one piece of viewing information received by the viewing information specification reception unit.

13. An information storage medium storing a program which causes a computer to function as:
a storage unit which stores identifiers in association with a plurality of pieces of viewing information to be output to a screen, at least one identifier is associated with a plurality of pieces of the viewing information;
a viewing information output unit which is configured to output a plurality of pieces of the viewing information to the screen simultaneously and outputs the viewing information to the screen;
an output viewing information identification unit which identifies the viewing information being output to the screen;
an identifier determination unit which references the storage unit and determines an identifier to be output to the screen on the basis of the viewing information identified by the output viewing information identification unit; and
an identifier output unit which outputs the identifier determined by the identifier determination unit to the screen.

14. A display processing method comprising:
a viewing information output step of outputting at least one of a plurality of pieces of viewing information to a screen;
an output viewing information identification step of identifying the viewing information being output to the screen;
an identifier determination step of referencing a storage unit which stores identifiers in association with a plurality of pieces of the viewing information to be output to a screen, at least one identifier is associated with a plurality of pieces of the viewing information, and determining an identifier to be output to the screen on the basis of the viewing information identified in the output viewing information identification step; and
an identifier output step of outputting the identifier determined in the identifier determination step to the screen.
